(19) United States
(12) Patent Application Publication
(10) Pub. No.: US 2011/0215673 A1
(43) Pub. Date: Sep. 8, 2011

(54) ULTRASONIC WAVE GENERATOR

(75) Inventors: HAI LAN, Tu-Cheng (TW); TAI-HSU CHOU, Tu-Cheng (TW)

(73) Assignee: HON HAI PRECISION INDUSTRY CO., LTD., Tu-Cheng (TW)

(21) Appl. No.: 12/888,387

(22) Filed: Sep. 22, 2010

(30) Foreign Application Priority Data
Mar. 5, 2010 (TW) 99106540

(51) Int. Cl. H02N 10/00

(52) U.S. Cl. 310/306

(57) ABSTRACT

An ultrasonic wave generator includes an ultrasound generating assembly, a power supply and a controller. The ultrasound generating assembly includes a thermoacoustic film comprising a carbon nanotube film, a first electrode and a second electrode. The first and second electrodes are connected to opposite ends of the thermoacoustic film. The power supply is configured for powering the ultrasound generating assembly. The controller electrically is coupled to the power supply and configured for alternately powering on and off the ultrasound generating assembly at a frequency of at least 20 kHz.

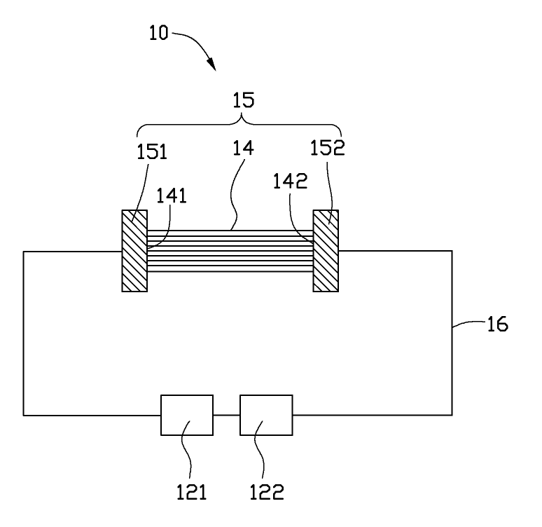

### BACKGROUND

1. Technical Field

The present disclosure relates to an ultrasonic wave generator, and particularly to an ultrasonic wave generator with a thermoacoustic film.

2. Description of Related Art

Ultrasonic wave generators have been widely used in a variety of applications, such as various detection sensors. An ultrasound may be generated by mechanical vibration or by energy conversion and propagation.

A typical ultrasonic wave generator uses a metal foil acting as a thermoacoustic element, and an alternating current applied on the thermoacoustic element. The thermoacoustic element has a low heat capacity and is thin, so that it can transmit heat to surrounding medium rapidly. When the alternating current passes through the thermoacoustic element, oscillating temperature is produced in the thermoacoustic element according to the alternating current. Heat wave excited by the alternating current is transmitted in the surrounding medium, and causes thermal expansions and contractions of the surrounding medium, and thus, a sound pressure is produced.

However, as the metal foil needs to have a low heat capacity and needs to be thin, to select the metal and machine the metal are difficult. Furthermore, as the alternating current is used, the metal foil needs to be very sensitive to the change of capacitance of the alternating current, otherwise resulting in an undesirable acoustic output.

What is needed, therefore, is an ultrasonic wave generator, which can overcome the above shortcomings.

### BRIEF DESCRIPTION OF THE DRAWING

Many aspects of the present ultrasonic wave generator can be better understood with reference to the following drawing. The components in the drawings are not necessarily drawn to scale, the emphasis instead being placed upon clearly illustrating the principles of the present ultrasonic wave generator.

The drawing is a schematic view of an ultrasonic wave generator in accordance with an embodiment.

### DETAILED DESCRIPTION

Embodiment of the present ultrasonic wave generator will now be described in detail below and with reference to the drawing.

Referring to the drawing, an ultrasonic wave generator 10 includes an ultrasound generating assembly 15, a power supply 121 and a controller 122. The ultrasound generating assembly 15 includes a thermoacoustic film 14, a first electrode 151, and a second electrode 152. The thermoacoustic film 14 is arranged between and supported by the first electrode 151 and the second electrode 152. The first electrode 151 and the second electrode 152 are electrically connected to the controller 12.

The thermoacoustic film 14 has a carbon nanotube film. The carbon nanotube film is capable of free-standing. A “free-standing” structure can be defined as a structure that does not have to be supported by a substrate. For example, a free-standing structure can sustain the weight of itself when it is hoisted by a portion thereof without any significant damage to its structural integrity. The free-standing structure of the carbon nanotube film is realized by the carbon nanotubes joined by van der Waals attractive force. So, if the carbon nanotube film is placed between two separate supporters, a portion of the carbon nanotube film not in contact with the two supports, would be suspended between the two supports and yet maintain film structural integrity.

The carbon nanotube film includes a plurality of carbon nanotubes uniformly distributed therein, and joined by van der Waals attractive force therebetween. The carbon nanotubes in the carbon nanotube film can be orderly arranged. The term ‘Ordered carbon nanotube film’ includes, but is not limited to, a structure where the carbon nanotubes are arranged in a consistently systematic manner, e.g., the carbon nanotubes are arranged approximately along a same direction. That is, the carbon nanotube film includes a plurality of parallel carbon nanotubes. The carbon nanotubes in the carbon nanotube film can be single-walled, double-walled, and/or multi-walled carbon nanotubes.

Macroscopically, the carbon nanotube film has a substantially planar structure. The planar carbon nanotube structure can have a thickness in a range about 0.1 micron to about 10 microns. The planar carbon nanotube structure can have a length in a range about 5 centimeters to 10 centimeters. A lengthwise direction of the planar carbon nanotube structure is shown in the drawing, which includes a first end 141 and a second end 142.

The first electrode 151 and the second electrode 152 are connected to the first end 141 and the second end 142, respectively, and thus supporting the planar carbon nanotube structure. The first electrode 151 and the second electrode 152 are electrically connected to the controller 12 by wire 16 to form a circuit loop of the ultrasound generating assembly 15.

The power supply 121 provides a direct current and a voltage of about 5 V to 12V. The controller 122 is coupled to the power supply 121 and configured for alternately powering on and off the circuit loop of the ultrasound generating assembly 15. A frequency of the alternation of the power-on and power-off of the circuit loop is at least 20 KHZ.

The first electrode 151 and the second electrode 152 are made of conductive material. The shape of the first electrode 151 or the second electrode 152 is not limited and can be lamellar, rod, wire, or block among other shapes. A material of the first electrode 151 or the second electrode 152 can be metals, conductive adhesives, carbon nanotubes, or indium tin oxides among other materials. In the present embodiment, the first electrode 151 and the second electrode 152 are rod-shaped metal electrodes. The carbon nanotubes of the thermoacoustic film 14 show excellent electrical conductivity along the lengthwise direction of the carbon nanotubes, and also provide a certain resistance to the circuit loop to avoid short circuiting problems.

The carbon nanotubes of the thermoacoustic film 14 each have a high specific surface area, thus under the van der Waals attractive force, the carbon nanotubes of the thermoacoustic film 14 show good adhesive ability. That is, the first end 141 and the second end 142 of the thermoacoustic film 14 can be directly adhered to the first electrode 151 and the second electrode 152, and form electrical contact thereon.

In addition, an electrically conductive adhesive layer can be applied between the first end 141 and the first electrode 151, and between the second end 142 and the second electrode 152 to further secure the thermoacoustic film 14 to the first and second electrodes 151, 152. In the present embodiment, the electrically conductive adhesive layer is a layer of silver adhesive.

Due to the carbon nanotubes of the thermoacoustic film 14 each have a high specific surface area, thus the carbon nanotube film has a low heat capacity and a large heat dissipation surface area. When the circuit loop is powered on, temperature of the thermoacoustic film 14 will increase rapidly, since the carbon nanotube film has a low heat capacity per unit area. And when the circuit loop is powered off, the temperature of the thermoacoustic film 14 can fall rapidly for the reason that the carbon nanotube film has a large heat dissipation surface area. That is, rapid thermal exchange can be achieved between the carbon nanotube film and the surrounding medium, such as a gas medium, and heat waves are rapidly propagated in surrounding medium according to variations of the power-on and power-off of the circuit loop, resulting in thermal expansions and contractions of the surrounding medium and the change of density of the surrounding medium. The at least 20 KHZ frequency of the alternation of the power-on and power-off of the circuit loop results that heat waves with at least at least 20 KHZ frequency, and the heat waves produce pressure waves in the surrounding medium, resulting in ultrasonic sound generation with good ultrasonic sound effects.

The surrounding medium can be sealed in a space, thus a better ultrasonic sound effect can be achieved.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An ultrasonic wave generator, comprising:
an ultrasound generating assembly including:
a thermoacoustic film comprising a carbon nanotube film;
a first electrode; and
a second electrode, the first and second electrodes connected to opposite ends of the thermoacoustic film;
a power supply configured for powering the ultrasound generating assembly; and
a controller electrically coupled to the power supply and configured for alternately powering on and off the ultrasound generating assembly at a frequency of at least 20 kHz.

2. The ultrasonic wave generator of claim 1, wherein the power supply is configured for applying a direct current to the carbon nanotube film.

3. The ultrasonic wave generator of claim 1, wherein the power supply is configured for applying a voltage to the carbon nanotube film, the voltage being in a range from 5 V to 12 V.

4. The ultrasonic wave generator of claim 1, further comprising a surrounding medium surrounding the carbon nanotube film, and the surrounding medium is air or a gas.

5. The ultrasonic wave generator of claim 1, wherein the carbon nanotube film is capable of free-standing.

6. The ultrasonic wave generator of claim 1, wherein the carbon nanotube film includes a plurality of parallel carbon nanotubes.

7. The ultrasonic wave generator of claim 1, wherein the carbon nanotube film has a thickness in a range from 0.1 microns to 10 microns, and has a length in a range from 5 centimeters to 10 centimeters.

8. The ultrasonic wave generator of claim 1, wherein the carbon nanotube film has a first end and a second end along a lengthwise direction thereof, the first end electrically contacting the first electrode, and the second end electrically contacting the second electrode.

9. The ultrasonic wave generator of claim 8, wherein an electrically conductive silver adhesive is applied between the first end and the first electrode, and applied between the second end and the second electrode.

10. An ultrasonic wave generator, comprising:
an ultrasound generating assembly including
a thermoacoustic film;
a first electrode; and
a second electrode, the first and second electrode electrically connected to opposite ends of the thermoacoustic film;
a power supply configured for applying a direct current to the ultrasound generating assembly for powering the ultrasound generating assembly; and
a controller electrically coupled to the power supply, the controller configured for alternately powering on and off the ultrasound generating assembly at a frequency of at least 20 kHz.

11. The ultrasonic wave generator of claim 10, wherein the thermoacoustic film comprises a carbon nanotube film.

12. The ultrasonic wave generator of claim 11, wherein the power supply is configured for applying a voltage to the carbon nanotube film, the voltage being in a range from 5 V to 12 V.

13. The ultrasonic wave generator of claim 11, further comprising a surrounding medium surrounding the carbon nanotube film, and the surrounding medium is air or a gas.

14. The ultrasonic wave generator of claim 11, wherein the carbon nanotube film is capable of free-standing.

15. The ultrasonic wave generator of claim 11, wherein the carbon nanotube film includes a plurality of parallel carbon nanotubes.

16. The ultrasonic wave generator of claim 11, the carbon nanotube film has a thickness in a range from 0.1 microns to 10 microns, and has a length in a range from 5 centimeters to 10 centimeters.

17. The ultrasonic wave generator of claim 11, wherein the carbon nanotube film has a first end and a second end along the lengthwise direction thereof, the first end attached to the first electrode, and the second end attached to the second electrode.

18. The ultrasonic wave generator of claim 17, wherein an electrically conductive silver adhesive is applied between the first end and the first electrode, and applied between the second end and the second electrode.
